(19) United States
(12) Patent Application Publication
(10) Pub. No.: US 2005/0061427 A1
(43) Pub. Date: Mar. 24, 2005

(54) Method for producing a leather ball having a simulated sewing pattern

(75) Inventor: Sahuts Srikijkarn, Amphur Meuang Samutprakarn (TH)

Correspondence Address: VOLPE AND KOENIG, P.C., UNITED PLAZA, SUITE 1600, 30 SOUTH 17TH STREET, PHILADELPHIA, PA, 19103, US

(73) Assignee: Siam Ball Sport Factory Co., Ltd., Amphur Meuang Samutprakarn (TH)

(21) Appl. No.: 10/929,130

(22) Filed: Aug. 27, 2004

(30) Foreign Application Priority Data
Sep. 19, 2003 (TH) 0303000936

(51) Int. Cl. B32B 31/00

(52) U.S. Cl. 156/265

(57) ABSTRACT

The method for producing a leather ball having a simulated sewing pattern.

### FIELD OF THE INVENTION

Engineering and chemical in the part of the method for produce leather ball looks like sewing pattern.

### SUMMARY OF THE INVENTION

The method for produce leather ball looks like sewing pattern comprising with steps of natural rubber mixed with chemical compounds to produce the ball which has three layers, inner ball or called bladder rubber, middle rubber layer and outer layer. The outer layer made from pieces of patterned leather or patch attached onto middle rubber layer and combined together by molding machine. Said pieces of leather can be prepared in desire pattern.

The method according to this invention can produce leather ball looks like sewing pattern and take less time than prior method. The product has durable quality and proof water.

### BRIEF DESCRIPTION OF THE_PRIOR ART

The ball production by conventional method is human hand-made. Of course they need the man skill in the art for sewing leather to make the ball. The ball come from this method are uncertain in quality and water can pass through the tiny needle holes. And the ball will downgrade easily.

### DETAILED DESCRIPTION OF THE INVENTION

The method for produce leather ball looks like sewing pattern comprising;

Step of making bladder rubber (also referred to as a rubber bladder).

Step of making middle rubber layer.

Step of making leather patches.

Step of combine leather patches onto middle rubber layer in order to making leather ball looks like sewing pattern.

Step of making bladder rubber

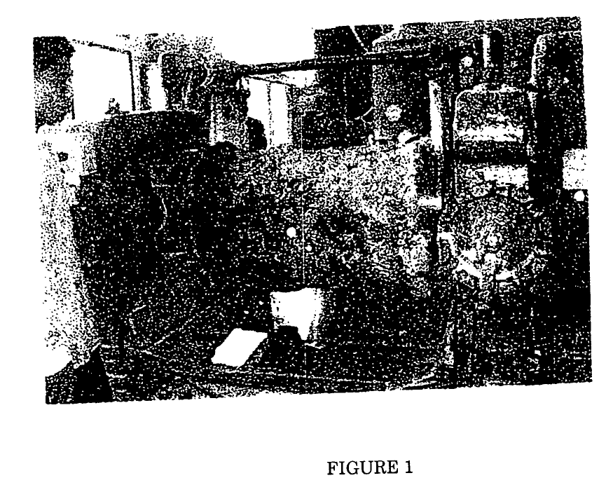

1. Bring the rubber mixed with MASTERBATCH and SB11 masticate for 2 minute (as shown in FIG. 1).

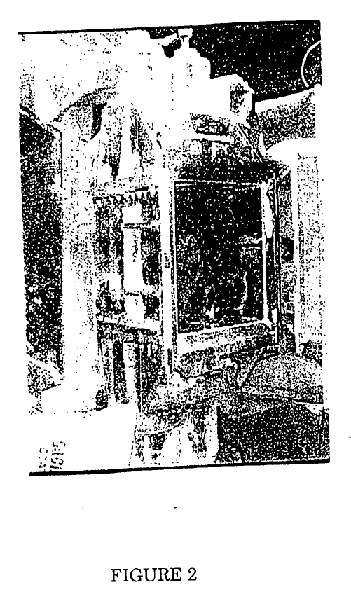

2. Bring the rubber from (1) mixing with chemical compound and masticate again for a minute. After that immerse this rubber in starch slurry and dry (as shown in FIG. 2).

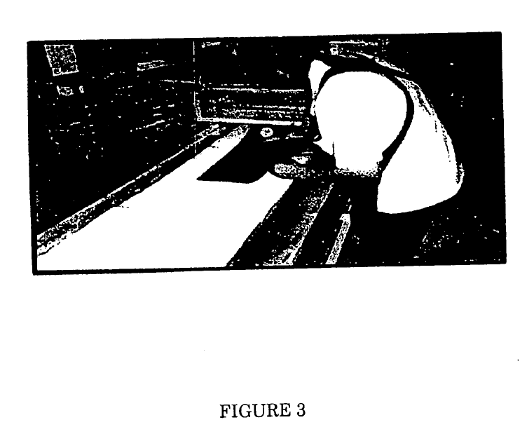

3. Bring the rubber from (2) masticate for 1 minute to make it softer then calender by calender machine at temperature 60-90° C. adjust the thickness for 0.90-0.95 mm. to make sheet of rubber (as shown in FIG. 3).

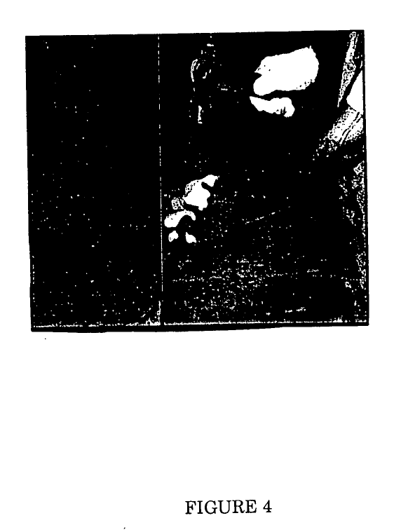

4. Bring the rubber sheet from (3) install the air filling tube at position about 9-12 inch from rim (as shown in FIG. 4).

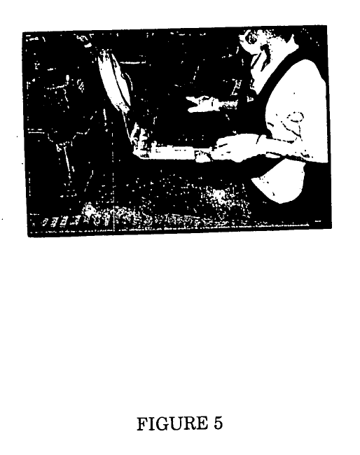

5. Bring rubber sheet from (4) fold and lay on knife block (round shape) to press and cut said folded rubber sheet at temperature 60-100° C. Now the folded rubber sheet is cut in round shape and sealed at the rim form bladder rubber. The weight is about 135-145 grams (as shown in FIG. 5).

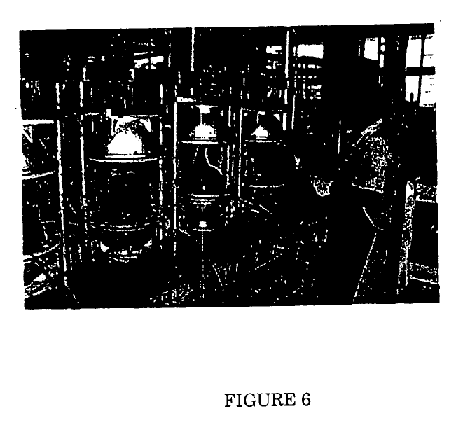

6. Curing the bladder rubber from (5) at temperature 155-165° C. by electric curing machine but for streamer curing machine the pressure should not less than 5.5 Kg/cm2 and curing time about 3 minutes (as shown in FIG. 6).

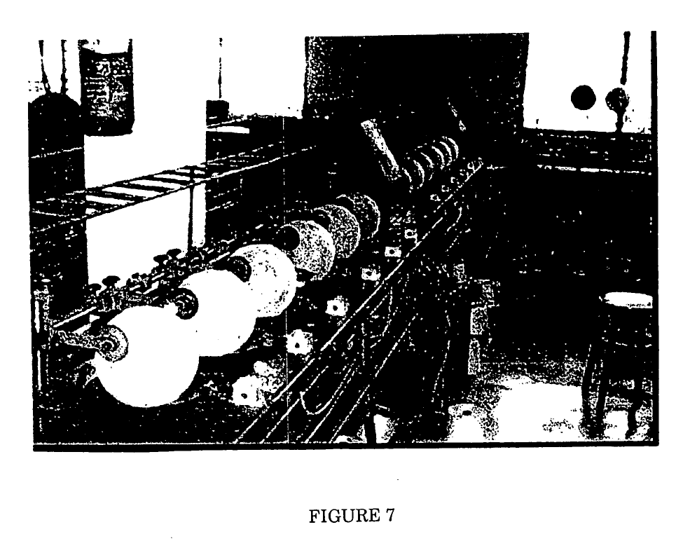

7. Bring the bladder rubber from (6) install the air filling tube valve. Compare the bladder rubber size with template if the size are equal, winding the bladder rubber by winding machine. Winding the bladder rubber will support the shape of ball in sphere all the time of use. The appropriate cycle is about 1,200 cycles or 7 minutes (as shown in FIG. 7).

Step of making middle rubber layer.

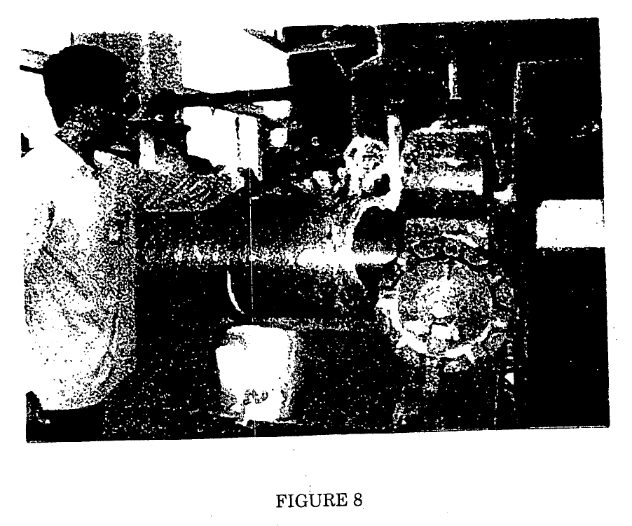

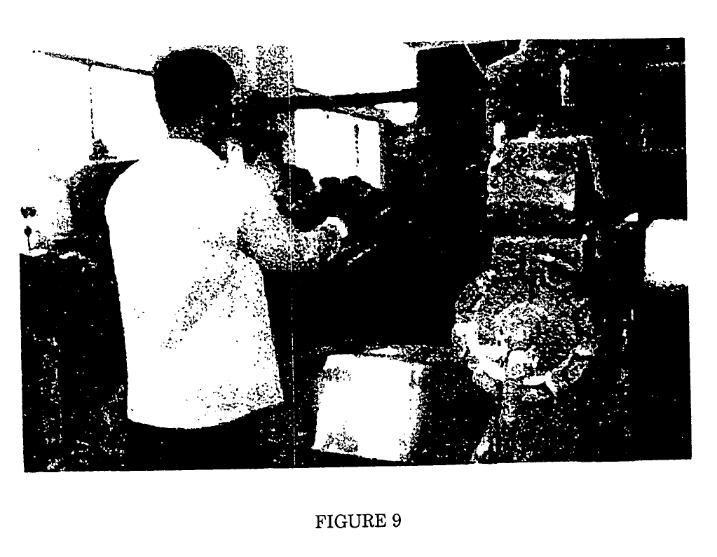

1. Mix natural rubber and synthetic rubber masticate for 2 minutes and mix with prepared chemical compound for 1 minute (as shown in FIGS. 8 and 9).

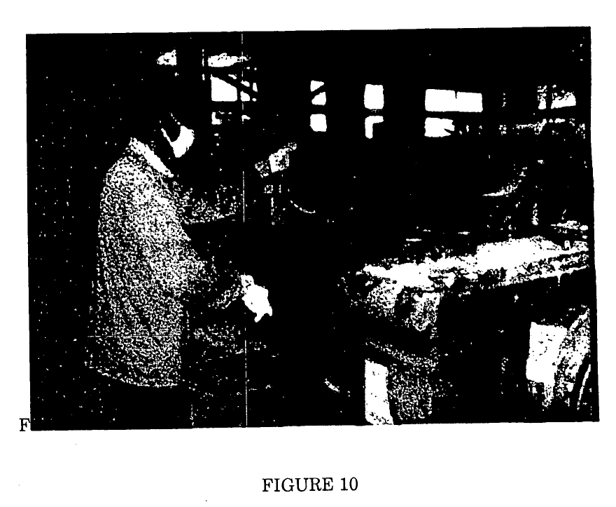

2. Bring the rubber from (1) mix with Sulphur and masticate about 5 minutes then immerse in starch slurry for a moment and then dry in the air (as shown in FIG. 10).

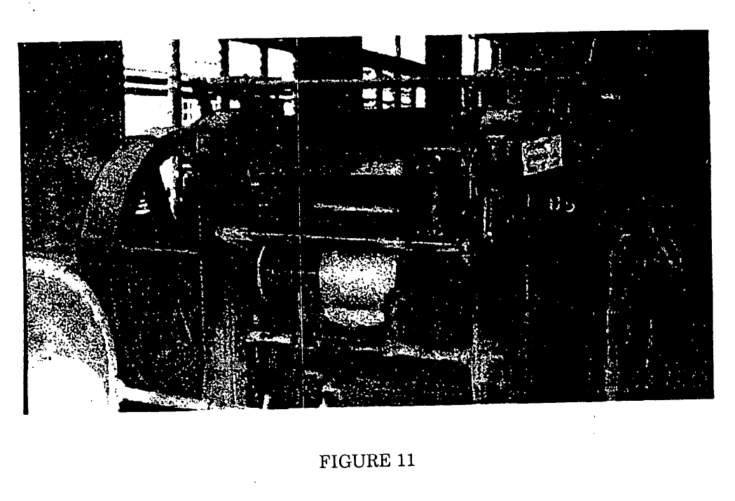

3. Bring the rubber from (2) masticate or knead for 1 minute until it become softer. Calender rubber by calender machine at temperature 60-90° C. and adjust the thickness of rubber sheet 0.70-0.75 mm (as shown in FIG. 11).

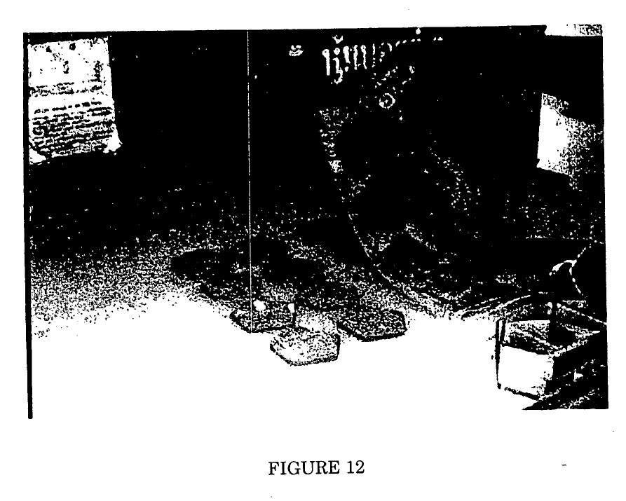

4. Cut rubber sheet from (3) into pieces in desired pattern. Now we will have pieces of rubber or rubber patches for attach onto bladder rubber (as shown in FIG. 12).

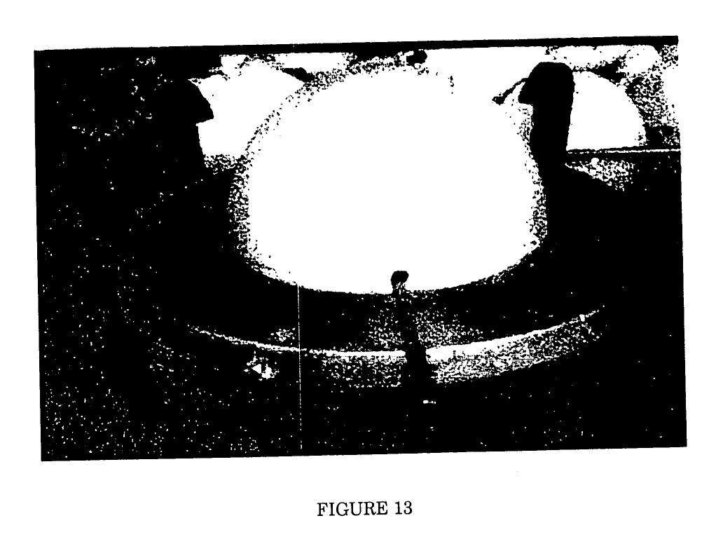

5. Bring pieces of rubber or patches from the above, attach into both sides of mold and bring winded bladder put on this mold and combine together in order to make middle rubber layer (as shown in FIG. 13).

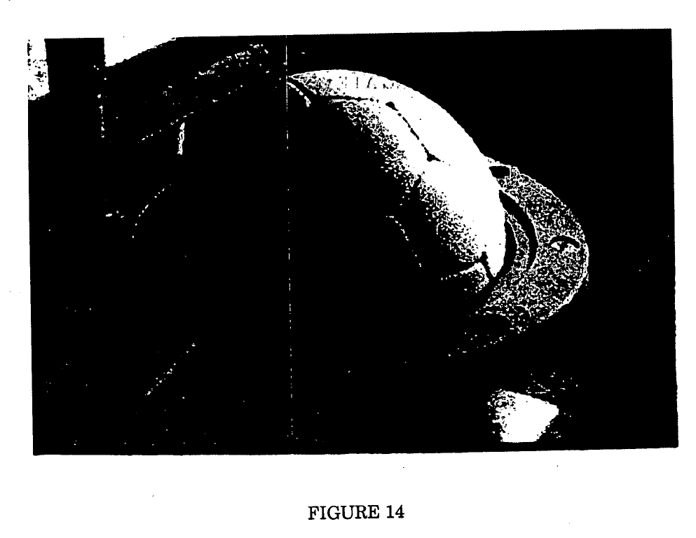

6. Curing (5) for 16 minutes (as shown in FIG. 14).

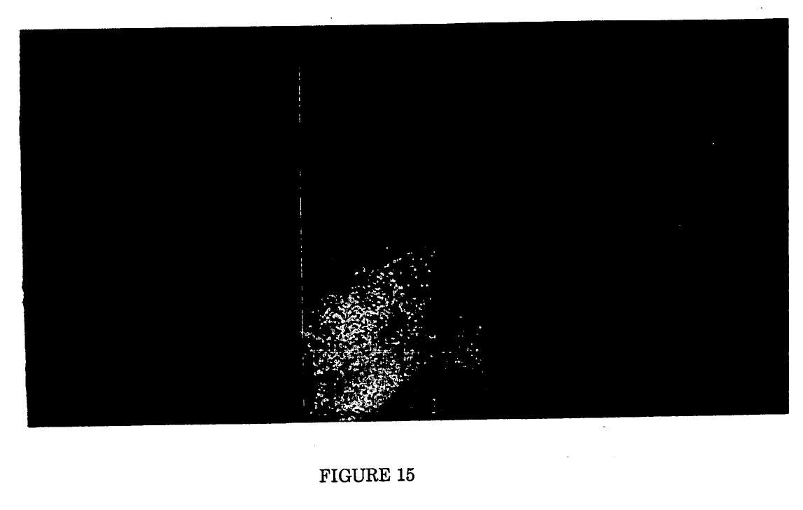

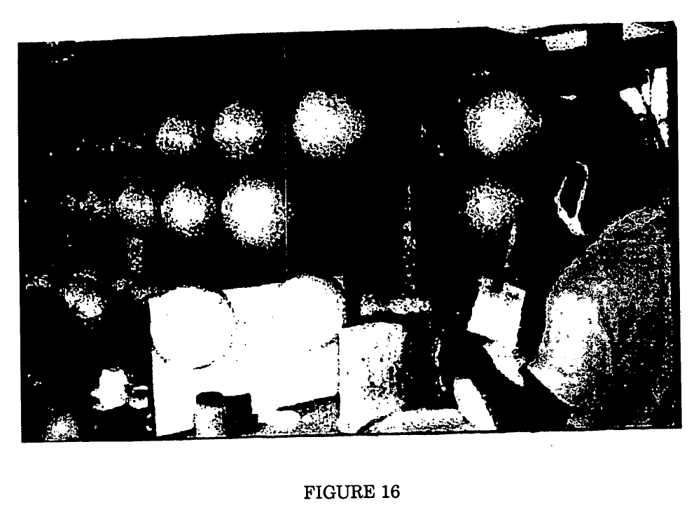

Install small air filling valve. Cleaning and gluing surface of middle rubber then hanging on conveyer rail passing heater and gluing one more time and heat again (as shown in FIGS. 15 and 16).

The following steps are additional steps from the method for produce laminated ball looks like sewing pattern.

Step of making leather patches.

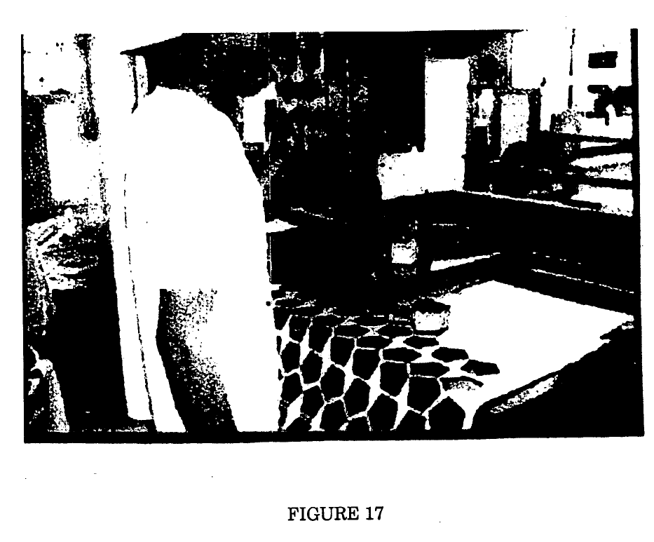

1. Bring the leather press cut by knife block into desire shape e.g. pentagon and hexagon shape. Now we have leather patches (as shown in FIG. 17).

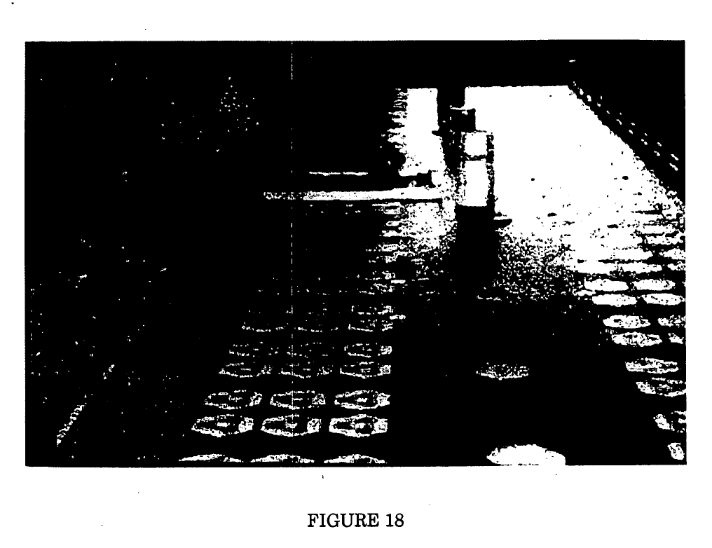

2. Screen any desired pattern if need onto leather patches and embossed it with high efficiency machine (as shown in FIG. 18).

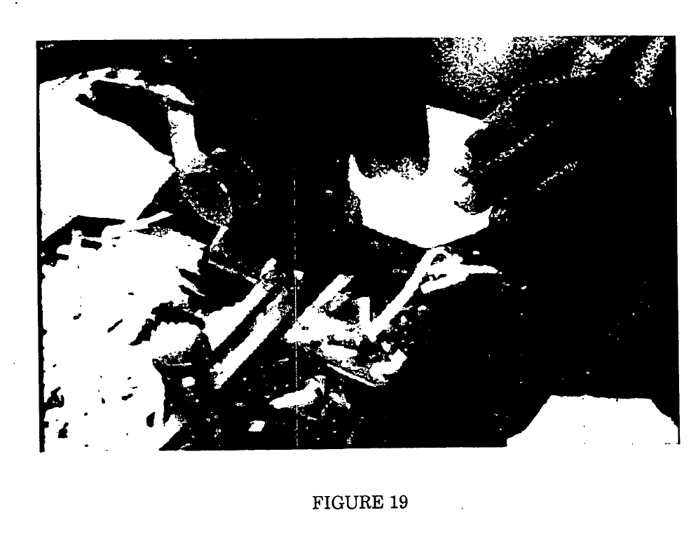

3. Sliding cut the rim at the back side of leather patches for size 4 mm. And the thickness of leather patches rim is about 0.5 mm (as shown in FIG. 19).

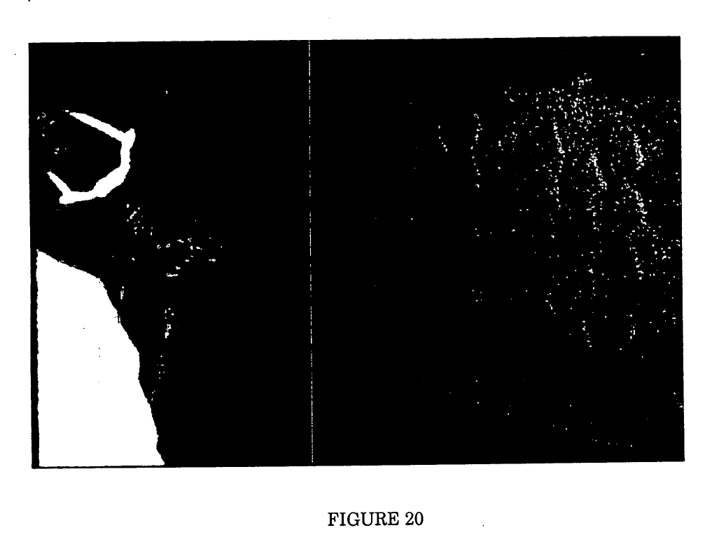

4. Treat the leather patch rim from (3) and gluing at the back side (as shown in FIG. 20).

Step of combine leather patches onto middle rubber layer in order to making leather ball looks like sewing pattern.

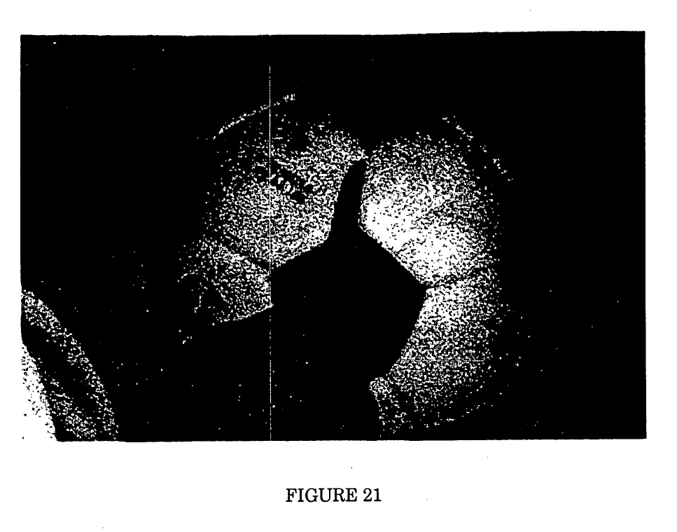

1. Bring the glued leather patches attach onto middle rubber layer, press firmly and especially at the rim (as shown in FIG. 21).

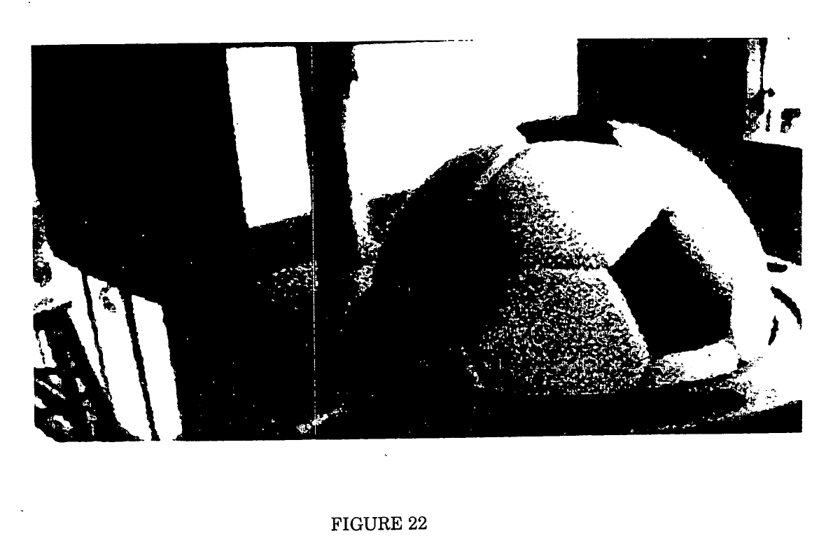

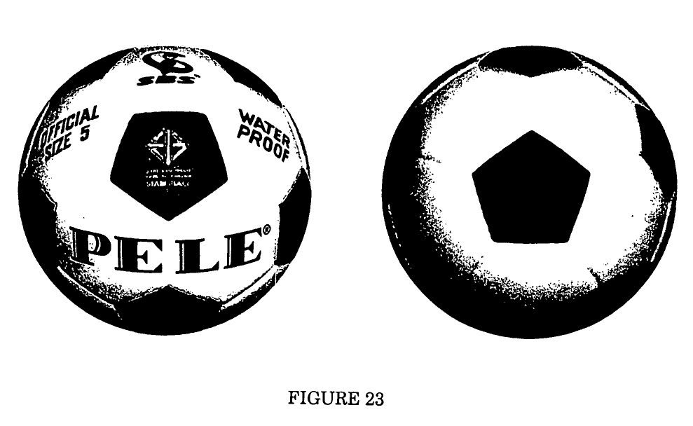

2. Curing the ball from (1) at temperature 40-50° C. for 90 seconds with this specific character mold which has ridge at the rim of leather patches on middle rubber. Install the small air filling tube. Fill air into the ball and cleaning to finish product (as shown in FIGS. 22 and 23).

Preferred formulation of MASTERBATCH (Mixed at Trap Products Co., Ltd.)

| Mixture Compounds | Weight | |
|---|---|---|
| RSS-1 | 50 | Kilograms |
| N-330 | 10 | Kilograms |
| N-550 | 17.5 | Kilograms |
| H-162 OIL | 5 | Kilograms |
| STEARIC ACID | 1 | Kilogram |
| ANTIOXIDANT SUNTIGHT-S | 1 | Kilogram |
| LOWINOX CPL | 500 | Grams |
| VOLKANOX MB-2/MG | 125 | Grams |
| TOTAL | 85.125 | Kilograms |

Rubber weight ± 200 grams

Preferred formulation for SB-11 (Mixed at Trap Products Co., Ltd.)

| Mixture Compounds | Weight | |
|---|---|---|
| BBX-2.2255 | 50 | Kilograms |
| N-550 | 10 | Kilograms |
| N-660 | 20 | Kilograms |
| 816 OIL | 3.3 | Kilograms |
| Ca Co., SUPER GRADE | 5 | Kilograms |
| STEARIC ACID | 930 | Grams |
| A-100 | 860 | Grams |
| TOTAL | 90.09 | Kilograms |

Rubber weight ± 200 grams

Preferred formulation for Inner rubber 30% (Main Machine)

| Mixture Compounds | Weight | |
|---|---|---|
| MASTERBATCH | 24 | Kilograms |
| SB 1 I | 9 | Kilograms |
| ZINC OXIDE 99.5% | 500 | Grams |
| TOTAL | 33.5 | Kilograms |
| PERKACIT TMTM | 50 | Grains |
| ACCEL DM-R (DM) | 25 | Grams |
| SANTOCURE MBS NOR) | 80 | Grams |
| CURAGENT-S | 360 | Grams |
| TOTAL | 34.01 | Kilograms |

Rubber weight ± 200 grams

List of Machines Preferably used in Manufacture of Rubber Material
1. Machine for mixing of rubber in close type (Internal Mixer)
2. Machine for mixing of rubber in open type (Open Mill)—Two Roll Mill
3. Machine for calendering rubber (Calender Machine)—Calender
4. Machine for folding of inner rubber
5. Machine for curing of inner rubber (Curing Mould)

1. A method for producing a leather ball with a simulated sewing pattern, comprising:
making a rubber bladder, comprising:
at least one of grinding, kneading, and mixing a rubber with MASTERBATCH and SB11 for approximately two (2) minutes;
at least one of grinding, kneading, and mixing the rubber with a chemical compound for approximately one (1) minute;
immersing the rubber in a starch slurry;
drying the rubber;
at least one of grinding, kneading, and mixing the rubber for approximately one (1) minute to make the rubber softer;
forming the rubber at a temperature of between approximately sixty (60) degrees Celsius and approximately ninety (90) degrees Celsius into a rubber sheet having a thickness of approximately zero point nine (0.9) millimeters and approximately zero point nine five (0.95) millimeters;
install an air filling tube in the rubber sheet at a position between approximately nine (9) inches and approximately twelve (12) inches from a perimeter of the rubber sheet;
form the rubber sheet at a temperature of between approximately sixty (60) degrees Celsius and approximately ninety (90) degrees Celsius into a round shape to form the rubber bladder having a weight of between approximately one hundred thirty-five (135) grams and approximately one hundred forty-five (145) grams;
curing the rubber bladder for approximately three (3) minutes at a temperature of between approximately one hundred fifty-five (155) degrees Celsius and approximately one hundred sixty-five degrees Celsiusc at a pressure of at least approximately five point five (5.5 Kg/cm2) kilograms per centimeter squared;
installing the air filling tub valve into the rubber bladder;
comparing a size of the rubber bladder with a template and if the size is accurate, winding the rubber bladder using approximately twelve hundred (1,200) cycles in a winding machine;
making a middle rubber layer, comprising:
preparing a rubber by mixing a natural rubber and a synthetic rubber for approximately two (2) minutes and then adding a coloring material and further at least one of grinding, kneading, and mixing the rubber for approximately five (5) minutes;
mixing the rubber with Sulphur for approximately five (5) minutes;
immersing the rubber in a starch slurry;
drying the rubber;
softening the rubber by at least one of grinding, kneading, and mixing the rubber for approximately one (1) minute;
calendaring the rubber at a temperature of between approximately sixty (60) degrees Celsius and approximately ninety (90) degrees Celsius to form a rubber sheet having a thickness of between approximately zero point seven (0.7) millimeters and approximately zero point seven five (0.75) millimeters;
cutting the rubber sheet into a plurality of rubber patches;
attaching the rubber patches into a mold and position the rubber bladder therein to form the middle rubber layer;
curing the rubber patches and the rubber bladder for approximately sixteen (16) minutes for 16 minutes;
installing an air filling valve in the middle rubber layer;
place an adhesive over the middle rubber layer;
making leather patches, comprising:
cutting a leather to form leather patches having a desired shape;
place any desired pattern onto the leather patches;
cutting generally along a perimeter of the leather patches along a surface of the leather patches that contacts the middle rubber layer to reduce a thickness of the leather patches along the perimeter;
applying adhesive to the surface of the leather patches;
combining the leather patches and the middle rubber layer to make a leather ball with a simulated sewing pattern, comprising:
attaching the leather patches to middle rubber layer to form the leather ball;
curing the leather ball for approximately one and one half (1.5) minutes at a temperature of between approximately forty (40) degrees Celsius and approximately fifty (50) degrees Celsius.

2. A method for producing a leather ball with a simulated sewing pattern, comprising:
making a rubber bladder;
making a middle rubber layer, comprising:
preparing a rubber by mixing a natural rubber and a synthetic rubber;
mixing the rubber with Sulphur;
immersing the rubber in a starch slurry;
softening the rubber by at least one of grinding, kneading, and mixing the rubber;
calendaring the rubber to form a rubber sheet;
cutting the rubber sheet into a plurality of rubber patches;
attaching the rubber patches into a mold and position the rubber bladder therein to form the middle rubber layer;
curing the rubber patches and the rubber bladder;
placing an adhesive over the middle rubber layer;
making leather patches, comprising:
cutting a leather to form leather patches each having a perimeter defining a desired shape;
cutting generally along the perimeter of at least one of the leather patches to reduce a thickness of the at least one leather patch along the perimeter;
placing the leather patches on the middle rubber layer to form a leather ball with a simulated sewing pattern.

3. A method for producing a leather ball with a simulated sewing pattern, comprising:
making a rubber bladder;
making a middle rubber layer positioned generally over the rubber bladder;
making leather patches, comprising:
cutting a leather to form leather patches each having a perimeter defining a desired shape;
cutting generally along the perimeter of at least one of the leather patches to reduce a thickness of the at least one leather patch along the perimeter;
securing the leather patches on the middle rubber layer to form a leather ball with a simulated sewing pattern.
